(19) United States
(12) Patent Application Publication
(10) Pub. No.: US 2015/0127412 A1
(43) Pub. Date: May 7, 2015

(54) WORKFLOW MANAGEMENT SYSTEM

(71) Applicant: AMAZON TECHNOLOGIES, INC., RENO, NV (US)

(72) Inventors: Raghunathan Kothandaraman, Bangalore (IN); Mukunda Nallur Srinivasagowda, Bangalore (IN); Andygibb Halim, Redmond, WA (US); Mark Aran Aiken, Seattle, WA (US); Praveen Dasigi, Vizianagaram (IN); Satish Kumar Vohra, Bangalore (IN)

(73) Assignee: AMAZON TECHNOLOGIES, INC., RENO, NV (US)

(21) Appl. No.: 14/133,283

(22) Filed: Dec. 18, 2013

(30) Foreign Application Priority Data
Nov. 4, 2013 (IN) 3262/DEL/2013

(51) Int. Cl. G06Q 30/06; G06Q 10/06

(52) U.S. Cl. CPC G06Q 30/0635; G06Q 10/06316
USPC 705/7.26

(57) ABSTRACT

A workflow management system can be implemented by one or more computing systems or services. The workflow management system may be used with a variety of different types of workflows, such as one or more fulfillment systems. The fulfillment systems can be any type of fulfillment system. For example, the fulfillment systems may fulfill orders for digital items, physical products, gifts, services, or a combination of digital products, physical products, services, and/or gifts. The orders may be electronic orders, orders placed via phone or mail, or the like.

### RELATED APPLICATIONS

This application claims the benefit of priority to Indian Provisional Patent Application No. 3262/DEL/2013, filed on Nov. 4, 2013 in India and titled “WORKFLOW MANAGEMENT SYSTEM,” the disclosure of which is hereby incorporated by reference in its entirety herein.

### BACKGROUND

It is often necessary to complete a series of steps to perform a task. For example, installing a new application on a computing device may include locating a copy of the application on a storage device, initiating installation of the application on the computing device, i.e., “target” device, and providing proof of license of the application. Often a task may be repeated a number of times within a variety of contexts. For example, the new application may be installed on a number of computing devices associated with an entity. In such a case, the task of installing the application may be repeated as many times as required to install a copy on each of the computing devices of the entity.

One way to describe the steps for completing a specific task is with a workflow. Workflows may describe the series of steps that are performed to complete the specific task or process. These workflows may exist in a variety of contexts. For example, a workflow may exist for configuring a new computer system for use by an employee at an organization or entity. As another example, a workflow may exist for installing and setting up a telephone line for a customer.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof.

FIG. 1 is a block diagram of an embodiment of a network computing environment for fulfilling network-based item orders.

FIG. 2 is a flowchart of an embodiment of an order fulfillment process.

FIG. 3 is a block diagram of an example of a master/child workflow implementation for processing an order.

FIG. 4 illustrates an example of a workflow descriptor.

FIG. 5 is a block diagram of an embodiment of a fulfillment system.

### DETAILED DESCRIPTION

### Overview

This disclosure is related to a workflow management system that can be implemented by one or more computing systems or services. While the workflow management system may be used with a variety of different types of workflows and systems, this disclosure will primarily be described with respect to managing workflows for one or more fulfillment systems. The fulfillment systems can be any type of fulfillment system. For example, the fulfillment systems may fulfill orders for digital items, physical products, gifts, services, or a combination of digital items, physical products, services, and/or gifts (generally referred to herein as “items”). The orders may be orders placed via a network with an electronic marketplace, orders placed via phone or mail, or the like.

A workflow implemented by the workflow management system may include a series of operations that are performed to complete a fulfillment process (or other type of process). For example, with respect to the completion of an electronic or network-based transaction for a physical item, the workflow may include operations that relate to obtaining payment, determining a warehouse from which to ship the physical item, determining the shipping method to use to ship the physical item, and updating inventory information and/or systems. As is clear from the above example, a workflow for fulfillment of a network-based transaction for a physical item can be quite complex. This complexity can make maintaining a workflow challenging. For example, it can be difficult to ensure that a modification to one operation of the workflow will not negatively impact other portions of the workflow.

In certain embodiments, the workflow management system can implement a master/slave, parent/child, or master/child workflow architecture (for convenience, collectively referred to herein as a “master/child architecture”). This master/child architecture may be used to facilitate management of network-based transactions for digital and/or physical items, and/or for services. The master workflow may be implemented by a master workflow engine, which may serve as a controller. The master workflow may determine a number of child workflows as well as the type of child workflows to instantiate. In some cases, the master workflow also maintains the child workflows. The master workflow may also perform additional processes or operations for the completion of a network-based transaction. The child workflows may be implemented by additional workflow engines that correspond to the type of child workflow. In some cases, the master workflow engine may implement at least some of the child workflows.

The master workflow may instantiate a child workflow from one or more templates associated with a particular series of steps to be performed in completing a process, such as a network-based transaction. For example, one workflow template may be associated with charging a credit card for a user, another workflow template may be associated with the selection of a warehouse for shipping an item, and another workflow template may be associated with updating inventory information for the purchased item. The master workflow may select any of these templates, among others, to instantiate a child workflow having the characteristics of the selected template. The master workflow can dynamically instantiate a child workflow at runtime of the workflow management system. Instantiating a child workflow may include instantiating a module, a child workflow engine, or other system capable of performing the child workflow. The type of system instantiated for performing the child workflow may depend on the type of child workflow. In certain embodiments, by dividing the steps in a fulfillment order into logical groupings of steps that may be implemented by different child workflows, the workflow management system can enable modifications to be made to a workflow template without negatively impacting other workflow templates. This ability of the workflow management system to use multiple child workflows to perform a single fulfillment transaction can, in some cases, simplify maintenance and control of complex workflows as well as the testing of modifications to workflows.

In certain embodiments, an order or transaction request may be received at an order server or a common ordering system. The transaction request may include a plurality of requested transactions. For example, the transaction request may include an order for three different physical items, one service, and two digital items. Further, a portion of the order may be intended as a gift for a recipient who may be located at a different residence than the user placing the order. The order server may include, implement, or call a customer order system. In some embodiments, the customer order system may include the master workflow engine. In other embodiments, the customer order system is separate from the master workflow engine. The customer order system may identify, based at least in part on the transaction request, a fulfillment system to process the transaction associated with the transaction request. In some cases, the transaction request may be divided among a number of fulfillment systems. For example, portions of the transaction request related to the physical items may be provided to a physical item fulfillment system for processing while portions of the transaction request related to digital items may be provided to a digital item fulfillment system for processing. In other cases, the entire transaction may be provided to a single fulfillment system for processing.

In some embodiments, the fulfillment system may include the master workflow engine that is configured to implement the master workflow. The fulfillment system may be implemented on or distributed across a number of computing systems. Similarly, the master workflow engine may be implemented in a distributed manner across a number of computing systems. The master workflow engine may dynamically identify and instantiate a number of child workflows based on the transaction to be fulfilled or completed. Each of these child workflows may be hosted by or executed on a number of additional computing systems associated with the fulfillment system. In some cases, at least a portion of a child workflow may be implemented on the same system as at least a portion of the master workflow. Further, in some cases, instantiating a workflow (child or master) may include instantiating a system or module to perform the workflow. In other cases, instantiating a workflow may include selecting a system to perform an instance of the workflow.

In some embodiments, a child workflow instantiates additional child workflows or grandchild workflows, and each of these workflows may in turn instantiate additional workflows, and the process may continue until the appropriate number and type of child workflows are instantiated for an order to be processed. In some such cases, the child workflow that instantiated the additional child workflows may serve as the master workflow for the additional child workflows. In other cases, the child workflow may hand control of the additional child workflows back to the master workflow.

In some embodiments, external systems (e.g., external to the workflow management system) are aware of the master workflow, but may not be aware of the child workflows. For example, the customer order system may, in some cases, be considered an external system. This customer order system may be aware of and may, in some cases, instantiate the master workflow engine to complete the order transaction. However, the customer order system may not be aware that the master workflow engine is instantiating additional workflows (e.g., the child workflows), or systems to process child workflows, to facilitate completion of the order transaction. In certain embodiments, being aware of the master workflow engine, or the master workflow, can include having access to or having access to an identifier of the master workflow engine or the master workflow.

In certain embodiments, the master workflow engine may create and maintain a workflow descriptor for each instantiated child workflow. This workflow descriptor may include any structure in memory that enables the master workflow engine to identify the child workflow and to maintain state information associated with the child workflow. For example, the workflow descriptor may be a table that includes an identifier associated with the child workflow and status information associated with the child workflow, such as whether the child workflow has completed operation, is awaiting information from another process, or has failed. In cases where the child workflow has failed, the master workflow engine may cause the child workflow to repeat an operation, or may instantiate a new child workflow to repeat the operation or to perform a different operation, such as a recovery operation. In some cases, the child workflow does not access the workflow descriptor, which is a construct created by the master workflow engine. However, in some cases, the child workflow may create a workflow descriptor for a grandchild workflow instantiated by the child workflow.

As used herein, the term “item,” in addition to having its ordinary meaning, is used interchangeably to refer to an item itself (e.g., a particular product) and to its description or representation in a computer system or electronic catalog. As will be apparent from the context in which it is used, the term is also sometimes used herein to refer only to the item itself or only to its representation in the computer system.

### Example Network Computing Environment

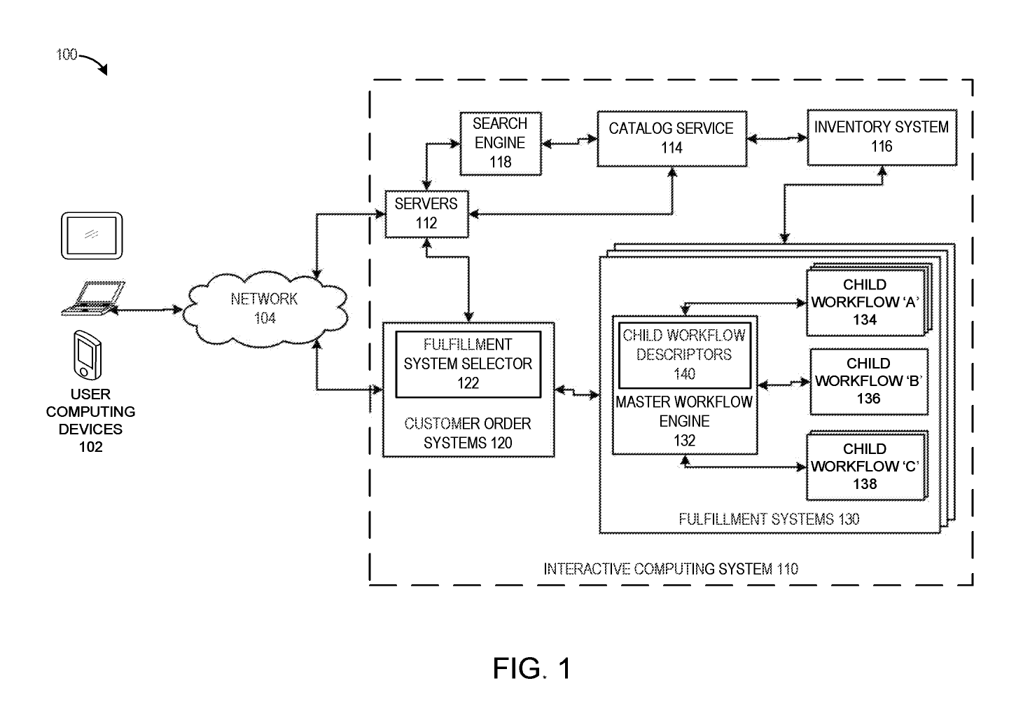

FIG. 1 illustrates an embodiment of a network computing environment 100 for fulfilling network-based orders for items. The network computing environment 100 can include a number of user computing devices 102 which may communicate with an interactive computing system 110 via a network 104.

As illustrated in FIG. 1, the user computing devices 102 may include a variety of different types of computing devices including any type of computing device that can communicate with the interactive computing system 110. For example, the user computing devices 102 include desktops, laptops, video game platforms, television set-top boxes, televisions (e.g., Internet TVs), computerized appliances, kiosks, and wireless mobile devices (e.g., smart phones, PDAs, tablets, electronic book readers, or the like), to name a few. Further, the user computing devices 102 may include any type of software that can facilitate communication with the interactive computing system 110. For example, the user computing devices 102 may include a browser or a mobile application configured to provide access to the interactive computing system 110. The network 104 can include any type of communications network. For example the network 104 may include one or more of a wide area network (WAN), a local area network (LAN), a cellular network, an ad hoc network, a satellite network, a wired network, a wireless network, etc., or any combination thereof. Further, in some cases, the network 104 may include the Internet.

The interactive computing system 110 may represent any computing system that can provide a user with access to a network application or service, such as a web application or website, for purchasing items. In certain embodiments, interactive computing system 110 may be a distributed computing system. In some embodiments, the interactive computing system 110 is associated with a network or Internet-based store, retailer, or electronic marketplace. In other words, in some cases, the interactive computing system 110 may implement an electronic commerce (or ecommerce) network site. In some cases, the interactive computing system 110 may be associated with a network-based store, such as a retail Internet website, that is affiliated with a brick-and-mortar store or retailer. The interactive computing system 110 can include a number of systems that facilitate processing a customer order for an item. Further, at least some of the systems of the interactive computing system 110 may be configured to perform the processes described herein. The systems of the interactive computing system 110 may include one or more servers 112, the catalog service 114, and inventory system 116, the search engine 118, one or more customer order systems 120, and one or more fulfillment systems 130. Each of the aforementioned systems may be implemented in hardware or software implemented by hardware. Further, at least some of the systems may be implemented by one or more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

The servers 112 can include any type of computing system for receiving and responding to requests from the user computing devices 102. Although the servers 112 are referred to as servers, the present disclosure is not limited to a client/server architecture. The requests processed by the servers 112 can include any type of command or interaction between the user computing devices 102 and the interactive computing system 110. For example, the request may include a request to search the catalog service 114 or to place an order for an item or service with the interactive computing system 110.

The search engine 118, which may be implemented in hardware and/or software implemented by hardware, can include any system for searching an electronic catalog. For example, the search engine 118 can search an electronic catalog provided by the catalog service 114. Both the search engine 118 and the catalog service 114 may be in communication with the servers 112. Users can browse an electronic catalog provided by the catalog service 114 or query the search engine 118 to obtain information about electronic catalog content stored in a item data repository (not shown).

The electronic catalog content can include information about items. In one embodiment, this content is arranged in a hierarchical structure, having items associated with one or more categories or browse nodes in a hierarchy. The catalog service 114 can provide functionality for users to browse the item hierarchy in addition to searching the catalog via the search engine 118.

In some cases, the hierarchical structure can include a tree-like structure with browse nodes that are internal nodes and with browse nodes that are leaf nodes. The internal nodes generally include children or descendent nodes and the leaf nodes generally do not include children nodes. The internal nodes may be associated with an item category or classification, which can include sub-classifications. The sub-classifications may represent additional internal nodes or leaf nodes. The leaf nodes may be associated with an item category or classification that does not include sub-classifications. In some implementations, the internal nodes are associated with item classifications and sub-classifications, but not items, and the leaf nodes are associated with the items. In other implementations, both the internal and leaf nodes may be associated with items.

The inventory system 116 can include any system for maintaining the inventory for a retailer. For example, the inventory system 116 may be configured to update a retailer's inventory each time a purchases made by a user or each time new inventories received at a warehouse of an entity associated with the interactive computing system 110.

The customer order systems 120 may include one or more computing systems for receiving an item order from a user (e.g., a customer). Further, the customer order systems 120 may provide the customer's order to a fulfillment system 130. As illustrated, in some cases the customer order systems 120 may include a fulfillment system selector 122. The fulfillment system selector 122 may include any system configured to select a fulfillment system 130 to process the customer's order. In some cases, the fulfillment system selector 122 may make a selection of a fulfillment system 130 based at least in part on the customer's order. For example, if the customer's order includes a purchase of a physical item, fulfillment system selector 122 may select a different fulfillment system 130 than if the customer's order includes only digital items.

The fulfillment systems 130 can include any system for the fulfillment of a customer's order. Each fulfillment system 130 may include a number of computing systems configured to perform a variety of tasks for fulfilling the customer's order. For instance the fulfillment system 130 may include systems for processing payment from the customer, selecting warehouse locations to fulfill orders for physical items, updating the inventory system 116, selecting a shipping method, and causing the physical item to be shipped to the customer. In some embodiments, when a fulfillment system 130 receives a customer order, the fulfillment system 130 may provide the order to a master workflow engine 132 to process. In some cases, the master workflow engine 132 may be a hardware system including one or more general purpose processors and/or application-specific processors. Alternatively, the master workflow engine 132 may be a software system or a combination of a hardware and software system. In some such cases, the fulfillment system 130 may instantiate a master workflow engine 132 for processing a customer order. Further, in some cases the master workflow engine 132 may be instantiated in response to the fulfillment system 130 receiving the customer order. Alternatively, the master workflow engine 132 may be instantiated by the customer order system 120. The customer order system 120 may instantiate the master workflow engine 132 when providing the fulfillment system with the order, or at any other time. In some cases, a master workflow engine 132 may be instantiated for each order to be processed. In other cases, a master workflow engine 132 may process multiple orders.

The master workflow engine 132 may be configured to implement a master workflow for the processing of the customer order. This master workflow may include a series of steps or operations for processing the customer's order. Further, the master workflow implemented by the master workflow engine 132 may include operations for identifying a number of different types of child workflows to facilitate completion of the customer's order. In addition to identifying the different types of child workflows, the master workflow may identify a number of each type of the child workflows to instantiate.

Although illustrated as included in the fulfillment system 130, in some cases the master workflow engine 132 may be included as part of a customer order system 120. In such cases, the customer order system 120 may instantiate or cause the master workflow engine 132 to perform a master workflow. Further in some such cases, the master workflow engine 132 may select the fulfillment system 130 from among the available fulfillment systems 130 to process the customer's order. In yet other embodiments, the master workflow engine 132 may be a separate system implemented in computer hardware or a combination of computer hardware and software. Alternatively, the master workflow engine 132 may be hosted by a system that is separate from the customer order system 120 and/or the fulfillment systems 130. In some cases, a customer order system 120 may provide a customer's order to the master workflow engine 132, and the master workflow engine 132 may select a fulfillment system 130 to process the customer's order. In some cases, the master workflow engine 132 may select multiple fulfillment systems 130 to process a customer's order. For example, if a customer's order includes both physical items and digital items, the master workflow engine 132 may select one fulfillment system 130 to process the physical items included in the customer's order and another fulfillment system 130 to process the digital items included in the customer's order.

In certain embodiments, the master workflow engine 132 may identify one or more child workflows to perform based on the customer's order. For instance, in the non-limiting example illustrated in FIG. 1, the master workflow engine 132 identified three types of child workflows to perform to complete processing of a customer's order at a particular point in time. These three types of child workflows include child workflow “A” 134, child workflow “B”136, and child workflow “C” 138. Further, as can be seen by the stacked boxes in FIG. 1, the master workflow engine 132 determine that three child workflows “A” 134, one child workflow “B” 136, and two child workflows “C” 138 should be performed to complete the customer's order. In other cases, or for processing other orders, more or less types of child workflows may be performed and more or less numbers of each type of child workflow may be performed to process an order.

Performing the child workflows may include instantiating one or more child workflow modules (not shown) to perform the child workflows. Thus, in some cases, the master workflow engine 132 may instantiate a child workflow module for each child workflow to be performed. In other cases, the master workflow engine 132 may instantiate a child workflow module for each type of child workflow to be performed. The child workflow modules may be specific to a particular order that is being processed. Alternatively, the child workflow modules may correspond to particular child workflow types regardless of the specific order being processed.

In some cases, the master workflow engine 132 may create and/or maintain one or more child workflow descriptors 140. The child workflow descriptors 140 may include a data structure for storing information associated with a child workflow (e.g., child workflow “A” 134). The information stored in the child workflow descriptors 140 can include any information that facilitates the master workflow engine 130 in accessing the child workflow or accessing a system implementing the child workflow. For example, information can include a child workflow identifier and status information for the child workflow, such as whether the child workflow has completed processing, whether the child workflow completed successfully, whether the child workflow is waiting for another child workflow to complete processing, etc. In some cases, the master workflow engine 132 may create a child workflow descriptor 140 for each child workflow instantiated by the master workflow engine 132.

Each child workflow may include a series of steps or processes for performing a portion of a process for fulfilling a customer's order. For example, one child workflow (e.g., child workflow “A” 134) may process a transaction for physical items (e.g., a television, a non-electronic book, a box of razors, etc.), another child workflow (e.g., child workflow “B” 136) may process payment for the customer's order (e.g., charge a credit card), and another child workflow (e.g., child workflow “C” 138) may process a transaction for digital items (e.g., a subscription to a video streaming service, a purchase of a game download, etc.).

In certain embodiments, systems external to the fulfillment systems 130 and/or external to the master workflow engine 132 may not be aware of the child workflows. For example, the customer order system 120 may not be aware that the master workflow engine 132 instantiated one or more child workflows to facilitate processing an order or transaction request.

### Example Order Fulfillment Process

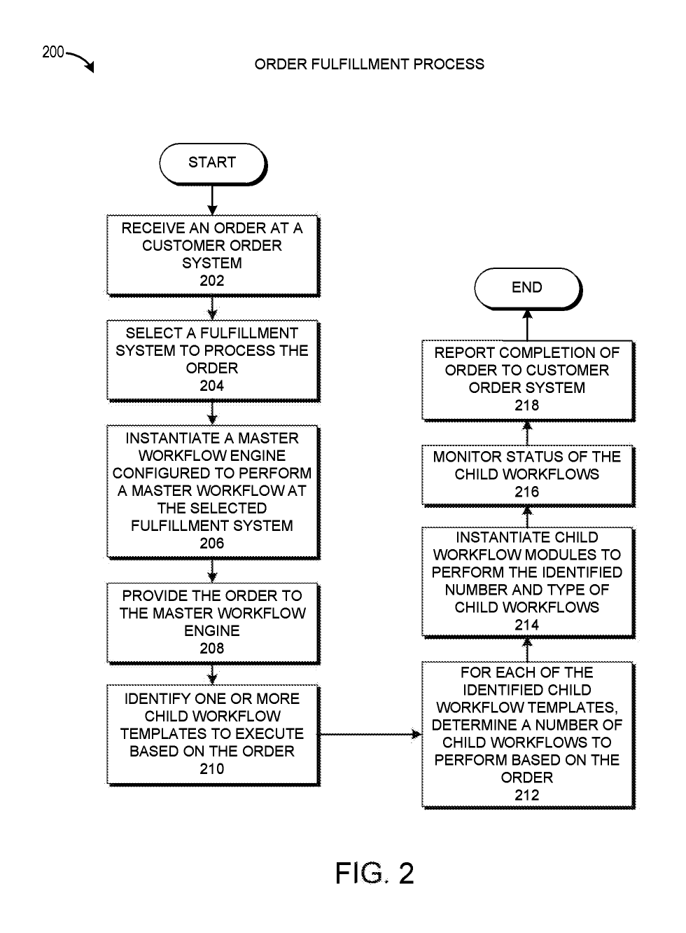

FIG. 2 presents a flowchart of an embodiment of an order fulfillment process 200. The process 200 can be implemented by any system that can process a network-based transaction (e.g., a purchase of items via an e-commerce website) by providing a transaction request to a master workflow, which is capable of dynamically selecting and instantiating a number of child workflows to facilitate completion of the transaction request. For example, the process 200, in whole or in part, can be implemented by the interactive computing system 110, the servers 120, the customer order systems 120, the fulfillment system 130, or the master workflow engine 132, to name a few. Although any number of systems, in whole or in part, can implement the process 200, to simplify discussion, portions of the process 200 will be described with reference to particular systems.

The process 200 begins at block 202 where, for example, an order or transaction request is received at a customer order system 120. The order may be received from a user computing device 102. Alternatively, the order may be received from a server 112, which may have received the order from a user computing device 102. In some cases, the order is received from an external customer (e.g., a user not affiliated with an entity that owns or controls the interactive computing system 110). In other cases, the order is received from a user affiliated with the entity that owns or controls the interactive computing system 110. For example, the order may be received from a group or organization affiliated with the entity of the interactive computing system 110 to order items from another group or organization affiliated with the entity of the interactive computing system 110. The order may include a request to purchase physical products, digital products, gifts, electronic currency or credits, and/or services.

At block 204, the fulfillment system selector 122 of the customer order system 120 selects a fulfillment system 130 to process the order. In some cases, the fulfillment system selector 122 may select multiple fulfillment systems 130 to process the order. In such cases, the order may be divided among the selected fulfillment systems 130. The order may be divided based upon the type of items in the order, payment methods used for different portions of the order, coupons applied to portions of the order, etc. For example, services may be processed by one fulfillment system 130, physical items by another fulfillment system 130, and digital items by yet another fulfillment system 130. In other cases, a single fulfillment system 130 may be selected to process an order regardless of the makeup or type of items in the order. In some cases, the fulfillment system 130 may be selected based on factors in addition to or other than the items included in the order. For example, the fulfillment system 130 may be selected based on the location of a user placing the order, or the location that items in the order are to be shipped. Other factors for selecting a fulfillment system 130 to process an order may include a type of payment used by the user or customer, whether the item is currently in stock, whether the order includes a preorder for an item not yet available, the location of the warehouse that includes the item, whether the order includes a gift purchase, and the like.

At block 206, the customer order system 120 or the fulfillment system selector 122 instantiates a master workflow engine 132 configured to perform a master workflow at the selected fulfillment system 130. Alternatively, the order is provided to the selected fulfillment system 130, and the selected fulfillment system 130 instantiates the master workflow engine 132 in response to receiving the order. In some embodiments, the block 206 may be omitted. For example, in some cases, the master workflow engine 132 may be a hardware system included with the fulfillment system 130 or may be a previously instantiated software module. In some embodiments, as previously described, the master workflow engine 132 may include computer hardware. In some such cases, the block 206 may be omitted. Alternatively, the block 206 may include selecting the master workflow engine 132 from among a plurality of master workflow engines. Selecting the master workflow engine may be based at least in part on the order, a portion of the order, the selected fulfillment system, the capacity of each of the master workflow engines, the queue of orders to be processed by the master workflow engine, and/or any other factor for selecting the master workflow engine from a plurality of master workflow engines.

The fulfillment system selector 122 for the customer order system 120 may provide the order to the master workflow engine at block 208. In some cases, the block 208 may include providing a portion of the order to the master workflow engine. For example, the order may be divided among a number of fulfillment systems 130, which may each include its own master workflow engine 132. As another example, it may be unnecessary to provide portions of the order or transaction request to system 130 because, for example, portions of the transaction request may be included for processing by other systems of the interactive computing system 110, such as the customer order system 120.

At block 210, the master workflow engine 132 identifies one or more child workflow templates to execute based at least partially on the order provided to it at the block 208. As previously described, child workflows may perform different operations or processes for facilitating processing of the order. The child workflow templates may include the series of steps or operations corresponding to a particular child workflow. For example, one child workflow template may exist for processing payment information and another child workflow template may exist for processing the purchase of services. To instantiate the child workflows to process the operation provided to the master workflow engine 132 at block 208, the master workflow engine 132 may select a number of corresponding child workflow templates. Thus, for example, to process an order including both physical items and digital items intended as gifts to another user, the master workflow engine 132 may select a child workflow template to process payment information, another child workflow template to process the purchase of the physical items, another child workflow template to process the purchase of the digital items, another child workflow template to process the purchase of gifts, another child workflow template to process the shipping of physical items, and another child workflow template to process the updating of an inventory system 116.

For each of the identified child workflow templates, the master workflow engine 132 determines a number of instances of the corresponding child workflow to be performed based at least partially on the order at block 212. For example, if the order includes a request to purchase three physical items, a master workflow engine 132 may determine that three child workflows corresponding to the child workflow template associated with the processing of the physical item orders should be instantiated, one for each physical item. At block 214, the master workflow engine 132 instantiates one or more child workflow modules to perform the identified number and type of child workflows. For example, continuing the above example, the master workflow engine 132 may instantiate three child workflow modules to perform the three child workflows corresponding to processing of the three physical items included in the order. Each of the three child workflows in this example may perform the operations or steps included in the child workflow template corresponding to the processing of the physical item orders. In some cases, by instantiating multiple child workflow modules, and order may be processed faster compared to systems that the process orders using a single workflow. For example, multiple portions of the order may be processed in parallel leading to greater efficiency of the processing of an order.

At block 216, the master workflow engine 132 monitors the status of each of the child workflows aim performed by the child workflow modules instantiated at the block 214. In some embodiments, monitoring the status of the child workflows may include creating a child workflow descriptor associated with each child workflow. As described above, the child workflow descriptor may include a number of pieces of information for monitoring and accessing the child workflow. For example, the child workflow descriptor may include an identifier for referencing the child workflow and information for accessing or communicating with child workflow module performing the child workflow. Further, the child workflow descriptor may include status information associated with the child workflow module performing the child workflow and status information associated with the child workflow itself. For example, the status information may identify whether the child workflow has completed, whether an error occurred in performing the child workflow, or whether the child workflow module is waiting on the execution of another child workflow.

At block 218, the master workflow engine 132 reports the completion of the processing of the order to the customer order system 120. Reporting the completion of the processing of the order may include identifying whether the order was processed successfully. If the order was not completed successfully, block 218 may include providing order status information indicating why the order was not successfully completed.

In some embodiments, the master workflow engine 132 may dispose of a child workflow module upon completion of the child workflow being performed by the child workflow module. Disposing of the child workflow module may include making resources used by the child workflow module available for use by other systems or by the master workflow engine 132 for processing other orders. In some embodiments, the child workflow module may not be disposed of on completion of the child workflow. Instead, in some cases, the child workflow module may be identified as available for use by other master workflow engines or for use with processing other orders.

Further, in some cases, the fulfillment system 130 may dispose of a master workflow engine 132 upon completion of an order. In other cases the master workflow engine 132 may be identified is available for processing additional orders. In some cases, the master workflow engine 132 may process multiple orders at least partially in parallel.

In some implementations, the blocks 210-218 may be performed as part of a master workflow executed by the master workflow engine. Further, in some cases, the master workflow is executed in response to the master workflow engine being instantiated or accessed at the block 206. Alternatively, the master workflow may be executed or initiated in response to the order being provided to the master workflow engine at the block 208.

### Example Master/Child Workflow

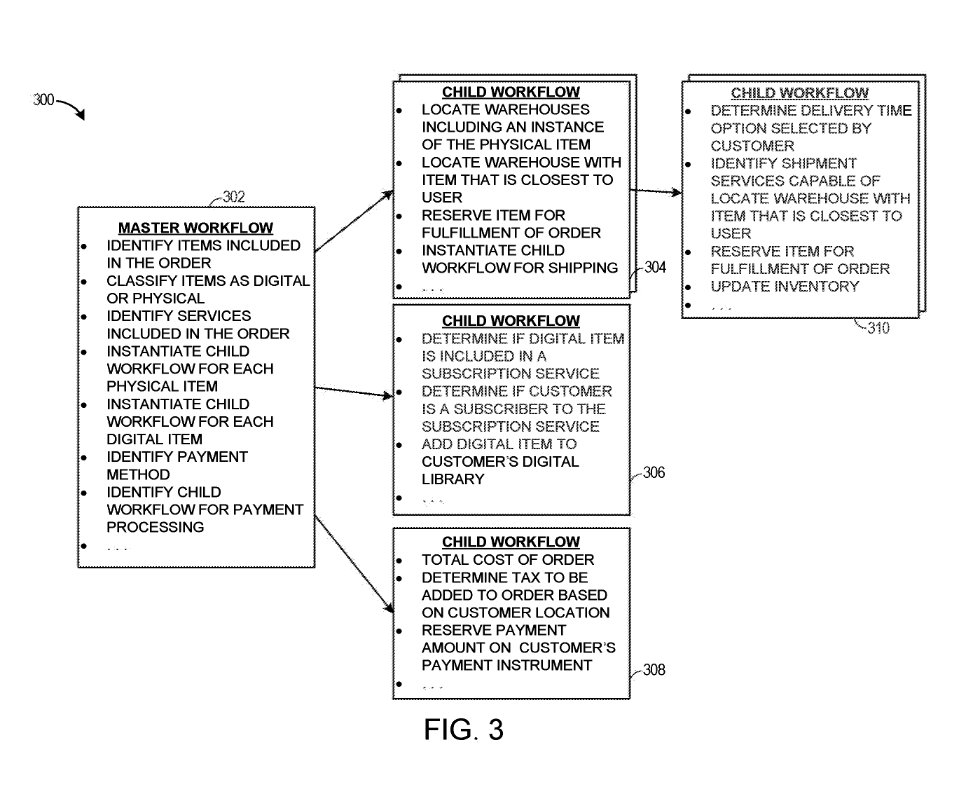

FIG. 3 illustrates an example of a master/child workflow 300 implementation for processing an order. The master/child workflow 300 is one non-limiting example of a master workflow and a number of child workflows performed by child workflow modules instantiated by a master workflow engine 132 performing the master workflow. Any number of alternative implementations is possible for the master/child workflow 300. The example illustrated in FIG. 3, the master/child workflow 300 includes a master workflow 302 and a number of child workflows 304, 306, 308. Further, the master/child workflow 300 includes child workflows 310 of the child workflow 304. These additional child workflows 310 may in some cases be referred to as grandchild workflows.

Although only two layers are illustrated in FIG. 3, any number of additional layers of child workflows is possible. The layers of child workflows may be organized in a hierarchical manner as shown in the illustrated embodiment of FIG. 3. However, alternative organizations for the child workflows are possible. For example, it may be possible for child workflows to depend on the outcome of processing a child workflow in the same hierarchical layer (e.g., the child workflow module processing the child workflow 308 may receive input from the child workflow module processing the child workflow 306). In some embodiments, child workflows, or the child workflow modules processing the child workflows, do not communicate with each other. In some such embodiments, the master workflow engine 132 may be aware of the status of a child workflow module or the child workflow the module is executing, but other child workflow modules may not be aware of the status of the child workflow module or its child workflow. Alternatively, a child workflow module may be aware of the status of another child workflow module or of the workflow performed by the other child workflow module. Further, in some cases, the master workflow engine 132 may perform a child workflow.

In the example illustrated in FIG. 3, the master workflow 302 includes a number of steps related to processing an order including, for example, identifying items in the order, determining whether the items are digital or physical, identify any services included in the order, instantiating child workflow modules to perform child workflows for the items included in the order, etc. Further, the master workflow 302 may include creating workflow descriptors to facilitate managing each of the child workflows, or child workflow modules for performing the child workflows instantiated by the master workflow 302.

The child workflows instantiated by the master workflow 302 may include one or more child workflows 304 for processing the purchase of a physical item, one or more child workflows 306 for processing the purchase of a digital item, and one or more child workflows 308 for processing payment for the order. Further, although not illustrated, a number of additional child workflows may be instantiated by the master workflow 302. For example, another child workflow may be instantiated processing the purchase of services. Moreover, in the example of FIG. 3, the one or more child workflows 304 cause one or more child workflows 310 to be performed to process shipping of the physical items included in the order. Thus, the child workflows 310 may, in some cases, be referred to as grandchild workflows. Causing a child workflow 310 to be performed may include causing a child workflow module performing the child workflow 304 to instantiate a new child workflow module to perform the child workflow 310. Alternatively, the child workflow 304 may cause the master workflow engine 132 to instantiate a new child workflow module to perform the child workflow 310.

In certain embodiments, an entity associated with the interactive computing system 110 may modify one or more child workflow templates corresponding to the child workflows. For example, the child workflow template corresponding to the child workflows 304 may be modified. In such cases, the child workflows 306 and 308 may be unaffected by the modifications to the child workflow template corresponding to the child workflows 304 because, for example, the child workflows 306 and 308 are based on different child workflow templates. In other words, a child workflow template corresponding to one type of child workflow may be modified without impacting child workflows based on other child workflow templates. In certain embodiments, by dividing a workflow into discrete master/child workflows, a workflow may be dynamically created or executed based on a received order and/or the result of executing a portion of the workflow. For instance, if a child workflow does not execute successfully, another child workflow may be dynamically executed. As a second example, if one child workflow determines that a selected item is no longer in inventory, the master workflow can dynamically instantiate another child workflow to order additional inventory.

In some embodiments, the master workflow may perform some steps relating to processing an order and cause one or more child workflows to execute to perform some steps relating to processing the order. In other embodiments, the master workflow may identify child workflows to execute and, in some cases, manage the modules executing the child workflows without performing steps relating to processing the order itself. In such cases, the order may be processed by the child workflows.

### Example Workflow Descriptor

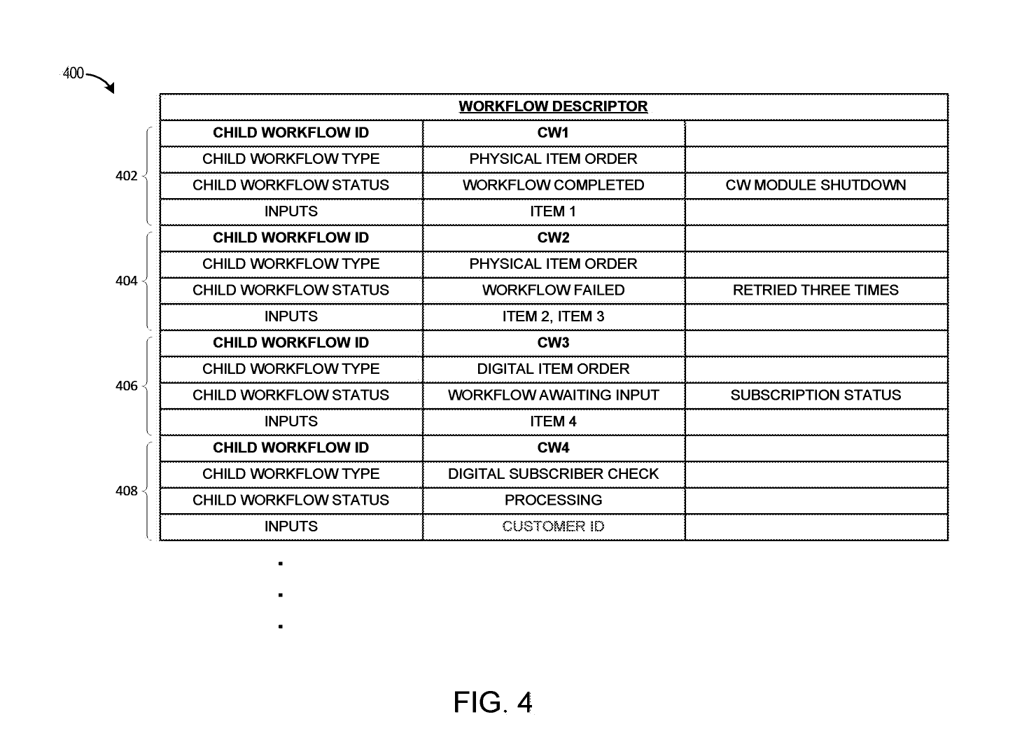

FIG. 4 illustrates a non-limiting example of a portion of a workflow descriptor 400. The workflow descriptor 400 may include any type of data structure for storing identification information and status information corresponding to one or more child workflows, or child workflow modules configured to perform a child workflow, instantiated by the master workflow engine 132. In some embodiments, a separate workflow descriptor may be created for each instantiated child workflow. In other cases, as illustrated in FIG. 4, a workflow descriptor may include status information for multiple child workflows.

In the example illustrated in FIG. 4, the workflow descriptor 400 includes information for at least four child workflows, entries 402, 404, 406, and 408. Each entry 402, 404, 406, 408 may include a number of different types of information. Further, some entries may include different information than other entries depending on the type of workflow corresponding to the entry. In the depicted example, the entries 402, 404, 406, and 408 include an identifier for the child workflow, a type of the child workflow, status information for the child workflow, and a list of inputs provided to the child workflow performing the child workflow. For example, for entry 402, the child workflow identifier is CW1; the type of the child workflow is a physical item order workflow; the status of the child workflow indicates that the workflow has completed executing; and the inputs indicate that the child workflow, or the child workflow module performing the child workflow, was provided with the identity of “ITEM 1” that was included in the order being processed. Further, entry 402 indicates that the child workflow module instantiated to perform a child workflow CW1 has been shut down. Entry 404 is also associated with a workflow CW2 of the physical item order type. However the status of the workflow corresponding to entry 404 indicates that the workflow failed to execute successfully. In addition, the entry 404 indicates that the workflow was retried three times. In some embodiments, if a workflow fails to successfully execute, an alert may be provided to another system (e.g., the customer order system 120) or to a user (e.g., an administrator). As can be seen with entry 404, in some cases multiple inputs (e.g., “ITEM 2” and “ITEM 3”) may be provided to a child workflow.

Entry 406 of the example workflow descriptor 400 corresponds to a digital item order workflow CW3. The status information associated with entry 406 indicates that that the workflow CW3 is awaiting input. Further, the status information of the entry 406 indicates that the input for which the child workflow is waiting is a subscription status for the customer. Entry 408 of the example workflow descriptor 400 corresponds to a digital subscriber check workflow CW4. The corresponding status information for entry 408 indicates that the workflow is currently being processed, or is executing. Further, the list of inputs to entry 408 indicates that the CW4 workflow received a customer identifier as an input, which it can use to determine if the customer associated with the customer identifier is a subscriber of a digital service (e.g., a video streaming service). In certain embodiments, when the child workflow CW4 corresponding to entry 408 of the workflow descriptor 400 finishes executing, the master workflow engine 132 may provide the child workflow CW3, or the child workflow module executing the child workflow CW3, with the subscription status information that the child workflow CW3 is awaiting. In other embodiments, the child workflow CW3 may poll the child workflow CW4 for the information that child workflow CW3 is awaiting.

As previously stated, the workflow descriptor 400 is one non-limiting example of a workflow descriptor. In certain embodiments, the workflow descriptor 400 may include a number of additional pieces of information associated with the executing child workflows. For example, the workflow descriptor 400 may indicate status information for grandchild workflows. As another example, the workflow descriptor 400 may identify the one or more physical machines performing each child workflow.

In certain embodiments, the determination of whether to instantiate child workflow modules to perform one or more child workflows corresponding with one or more child workflow templates may be based on a finite state machine or an abstract finite state machine. The master workflow engine 132, as part of processing the master workflow, may use the finite state machine to make a decision, based on an event, of whether to cause a new child workflow to be performed. The event may include receiving or processing an order, or any event relating to the processing of an order. For example, the event may include receiving an indication that an item is out of stock, receiving an indication that inventory is low for an item, receiving an indication that a customer's subscription to a subscription service (e.g., a digital library or a priority shipping service) has expired, and the like. Further, as previously stated, embodiments described herein may be utilized for processes other than for order processing. For example, embodiments herein may be used as part of a recommendation service. In such a case, events that trigger determining whether a new child workflow module should be performed may include determining whether a new item has been released, whether a customer has made a purchase within a particular time period, whether a customer has recently made a purchase, etc.

In some cases, the finite state machine may also be used to determine whether a message or data should be provided to a child workflow or the child workflow module performing the child workflow. Further, in some cases the finite state machine may identify whether a control message or data should be provided to the child workflow module. The data may include any type of data that may be processed by a workflow including, for example, data included as part of an order or data related to execution of another workflow. Further, the control message may include any command related to a child workflow or child workflow module. For example, the command may be to cease performance of a workflow, to shut down a child workflow module, to retry a workflow, to provide the result of the workflow to another workflow, etc.

Moreover, the finite state machine may be used to determine which child workflow should receive a particular message based on an event, such as the completion of another workflow or a modification to an order. For example, the finite state machine may indicate that when a workflow related to determining whether a user (e.g., a customer) is a subscriber of a particular service completes, the response should be provided to another workflow, such as a workflow related to providing the user with access to an item associated with the particular subscription service. In addition, the message to be provided to a workflow may, in some cases, be determined based on the finite state machine. Further, the master workflow may use the finite state machine to determine whether to provide a message to a customer order system 120 or other system external to the fulfillment system 130. For example, the master workflow may determine that, when a particular child workflow has failed to complete executing successfully, an error message should be provided to the customer order system.

As previously discussed, in some embodiments, a child workflow module may be reused. In such embodiments, the master workflow may include determining, based on the finite state machine and information included in the workflow descriptor 400, whether a new child workflow module should be instantiated to perform a child workflow, or whether an existing child workflow module can be used to perform the child workflow. For example, suppose that an order includes four physical items and one digital item. The master workflow may instantiate two child workflow modules configured to perform a child workflow for charging a customer's payment instrument (e.g., a credit card). By instantiating multiple child workflow modules, multiple workflows for charging the payment instrument can execute in parallel. Each child workflow can charge the payment instrument for two of the physical items. Now suppose that the two physical items being processed for payment by one of the child workflows is cancelled. In such a case, the master workflow may determine to reuse the child workflow module to perform the child workflow to charge the payment instrument for the digital item. This determination may be made by using the finite state machine to determine whether the child workflow module is available and whether the child workflow module is configured to perform the type of child workflow for charging a payment instrument.

In some cases, a particular child workflow module performs one type of workflow, once or a number of times. In other cases, the particular child workflow module may be capable of performing workflows corresponding to multiple child workflow templates. Thus, the finite state machine may include determining not only that a child workflow module is available for performing a child workflow, but also whether an available child workflow module can be utilized to perform a required child workflow, or whether a new child workflow module is necessary despite the existence of an idle child workflow module due to type requirements.

In some embodiments, the transitions between finite state machine states may be based on the status information included in the workflow descriptor 400 and the occurrence of an event. For example, suppose the master workflow engine 132 is at a state that involves parsing an order to process the various items of the order. If the order includes a physical item, the master workflow engine 132 may proceed to a first state that involves providing the order to a child workflow module for processing in a corresponding child workflow if the workflow descriptor 400 indicates that a child workflow module is available to process the physical item. If the workflow descriptor 400 indicates that a child workflow module is not available, the master workflow engine 132 may proceed to a second state that involves instantiating a new child workflow module.

### Example Fulfillment System

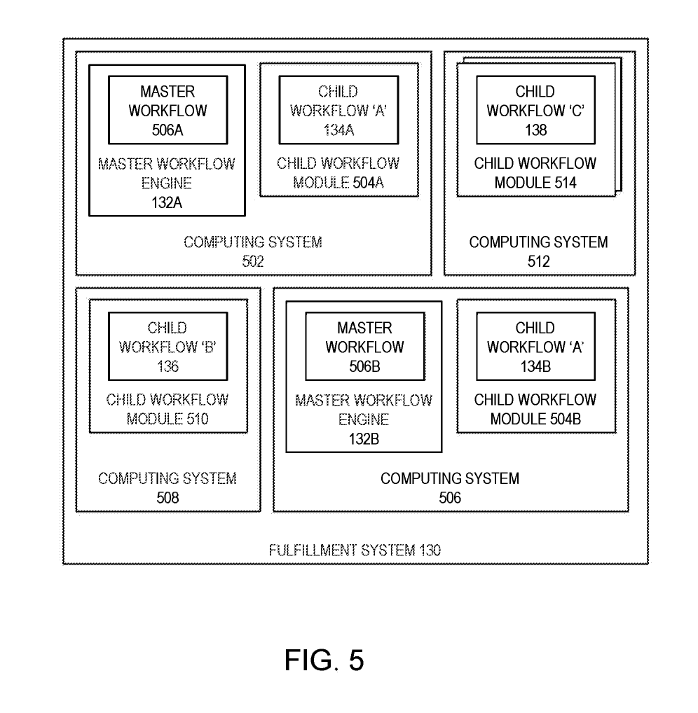

FIG. 5 is a block diagram of an embodiment of a fulfillment system 130. As previously discussed with respect to FIG. 1, the fulfillment system 130 may include a master workflow engine 132 that performs a master workflow. Further, as discussed with respect to FIG. 1, the systems of the fulfillment system 130 may perform one or more child workflows. Each of the master workflow engine 132, the master workflow, and the one or more child workflows may be performed on a single computing system or may be performed in a distributed computing environment. FIG. 5 illustrates one non-limiting example of the distribution of the master workflow engine 132 and a set of workflows among various operating units of the fulfillment system 130. It should be appreciated that FIG. 5 is but one example of a fulfillment system 130 and that other fulfillment systems 130 may include more or less operating units (e.g., computing systems) and may perform more or less workflows (e.g., master workflows and child workflows).

In the example depicted in FIG. 5, the fulfillment system 130 includes computing systems 502, 506, 508, and 512. Each of these computing systems 502, 506, 508, 512 may include any type of computing system. Further, in some cases, the computing systems 502, 506, 508, 512 may each be the same type of computing system or may be different types of computing systems. For example, the computing systems 502 and 506 may comprise order processing systems, the computing system 508 may comprise a billing system, and the computing system 512 may comprise an industrial appliance with computational logic for accessing items on shelves in a warehouse.

As previously stated, the master workflow engine 132 may be an independent system comprising hardware, software, or a combination of hardware and software. However in some cases, the master workflow engine 132 may be hosted by a computing system. In some cases, the master workflow engine 132 may be distributed among multiple computing systems. This is illustrated in FIG. 5 by the master workflow engine 132A hosted by computing system 502 and the master workflow engine 132B hosted by the computing system 506. In this example, the master workflow engine 132A and the master workflow engine 132B are distributed components of the master workflow engine 132. Further, the master workflow 506A and the master workflow 506B are portions of a single master workflow performed by the master workflow engine 132A and the master workflow engine 132B, respectively.

As illustrated by the child workflow module 504A and the child workflow module 504B, which are distributed components of the same child workflow module, the child workflow modules may also be distributed across multiple computing systems. Further, the distributed child workflow modules may perform a child workflow in a distributed manner. For example, execution of the child workflow “A” 134 may be distributed among multiple computing systems 502, 506, which each host a particular child workflow module comprising child workflow module 504A and 504B.

As illustrated with the child workflow module 510, a child workflow module may be hosted by a single computing system 508. Further, as illustrated by the computing system 512, a computing system may host multiple child workflow modules 514, which can perform multiple instances of a child workflow “C” 138.

Although the various systems illustrated in FIG. 5 shown as part of a single fulfillment system 130, it is possible for the systems to be shared by multiple fulfillment systems or to be distributed among multiple fulfillment systems. Further, some systems may be shared or distributed between a fulfillment system 130 and other systems, such as customer order system 120, inventory system 116, or one or more servers 112. In addition, although the fulfillment system 130 illustrates a single master workflow engine distributed among multiple computing systems, is possible for the fulfillment system 132 include multiple master workflow engines which may or may not be distributed among the computing systems of the fulfillment system 130. For instance, in some cases, a master workflow engine may be instantiated for each order processed by fulfillment system 130. In other cases, the master workflow engine may process multiple orders.

### Additional Embodiments

In certain embodiments, a computer-implemented method for processing an order can be performed under the control of a physical computing system implementing specific computer-executable instructions. The method can include receiving an order for a number of items and identifying a number of child workflow templates to execute based at least partially on the order. Each child workflow template may be associated with a workflow comprising one or more steps to be performed in processing the order. Further, for each child workflow template of at least some of the identified number of child workflow templates, the method may include instantiating a child workflow module. The instantiated child workflow module may be configured to perform the workflow associated with the respective child workflow template. Moreover, the workflow may be associated with a master workflow for processing the order.

In some embodiments, the method includes instantiating a master workflow engine to perform the master workflow. Further, the master workflow engine may be implemented in a distributed computing system. In some cases, at least one of the instantiated child workflow modules is implemented in a distributed computing system. The master workflow may be performed by a master workflow engine comprising computer hardware.

The order, in some implementations, is received from a customer order system configured to select a fulfillment system for fulfilling the order from a plurality of fulfillment systems. Further, a master workflow engine configured to perform the master workflow may be instantiated at the fulfillment system.

Moreover, the method may include generating a workflow descriptor for at least some of the instantiated child workflow modules. The workflow descriptor may reflect the status of each instantiated child workflow module and corresponding workflow. In addition, the method may include receiving status information for at least some of the workflows performed by the instantiated child workflow modules.

In some embodiments, the method includes determining a number of times to perform each child workflow template and instantiating a corresponding number of child workflow modules to perform the workflow associated with the respective child workflow template. Further, the method may include shutting down a child workflow module upon completion of a workflow being executed by the child workflow module. In addition, the method may include causing a child workflow module to execute a workflow a second time in response to the workflow failing to execute successfully a first time. Moreover, the method may include causing a child workflow module to execute a second workflow upon the child workflow completing execution of a first workflow. In some cases, the first workflow and the second workflow correspond to the same child workflow template. In other cases, the first workflow and the second workflow correspond to different child workflow templates.

In certain embodiments, the method includes determining whether to instantiate a child workflow module to perform a workflow corresponding to a child workflow template based on a finite state machine. Further, the method may include determining whether to cause an existing child workflow module to perform a workflow corresponding to a child workflow template based on a finite state machine. The method may also include determining whether to provide data to a child workflow module based on a finite state machine. Moreover, the method may include determining whether to send a command to a child workflow module based on a finite state machine.

### TERMINOLOGY

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

It is to be understood that not necessarily all such advantages can be achieved in accordance with any particular embodiment of the embodiments disclosed herein. Thus, the embodiments disclosed herein can be embodied or carried out in a manner that achieves or optimizes one advantage or group of advantages as taught herein without necessarily achieving other advantages as may be taught or suggested herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A computer-implemented method comprising:
under control of a physical computing system implementing specific computer-executable instructions,
receiving an electronic order for a number of items;
identifying a plurality of child workflow templates based at least partially on the electronic order, wherein each child workflow template is associated with a workflow comprising one or more steps to be performed in processing the electronic order; and
for each child workflow template of at least some of the identified plurality of child workflow templates, instantiating a child workflow module, wherein the instantiated child workflow module, when executed by a computing system, is configured to perform the workflow associated with the respective child workflow template, and wherein the workflow is associated with a master workflow for processing the electronic order.

2. The computer-implemented method of claim 1, wherein the electronic order is received from a customer order system configured to select a fulfillment system for fulfilling the electronic order from a plurality of fulfillment systems, and wherein a master workflow engine configured to perform the master workflow is instantiated at the fulfillment system.

3. The computer-implemented method of claim 1, further comprising generating a workflow descriptor for at least some of the instantiated child workflow modules, the workflow descriptor reflecting status of each instantiated child workflow module and corresponding workflow.

4. The computer-implemented method of claim 1, further comprising receiving status information for at least some of the workflows performed by the instantiated child workflow modules.

5. The computer-implemented method of claim 1, further comprising determining a number of times to perform each child workflow template and instantiating a corresponding number of child workflow modules to perform the workflow associated with the respective child workflow template.

6. The computer-implemented method of claim 1, further comprising determining an interaction to perform with respect to a child workflow module based on a finite state machine.

7. A system comprising:
a data store configured to store a master workflow; and
a master workflow engine comprising one or more hardware processors executing specific computer-executable instructions, the master workflow engine configured to receive an order for at least one item and to perform the master workflow for processing orders, wherein performing the master workflow comprises:
identifying a plurality of child workflow templates based at least partially on the order, wherein each child workflow template is associated with a workflow comprising one or more processes to be performed in processing the order; and
for each child workflow template of the plurality of child workflow templates, instantiating at least one child workflow module, that when executed by a computing system, performs a workflow corresponding to the child workflow template.

8. The system of claim 7, wherein the order is received from a customer order system configured to select a fulfillment system for processing the order from a plurality of fulfillment systems.

9. The system of claim 8, wherein the fulfillment system comprises the master workflow engine.

10. The system of claim 8, wherein the system is distinct from the customer order system.

11. The system of claim 7, wherein performing the master workflow further comprises generating a workflow descriptor entry in a workflow descriptor for at least some of the instantiated child workflow modules.

12. The system of claim 11, wherein the workflow descriptor entry comprises status information for the corresponding instantiated child workflow module.

13. The system of claim 7, wherein identifying the plurality of child workflow templates further comprises determining a plurality of child workflow modules to instantiate for each child workflow template based at least in part on the order.

14. The system of claim 7, wherein the master workflow engine is further configured to determine an interaction with a child workflow based at least in part on a finite state machine.

15. The system of claim 7, wherein the master workflow engine is further configured to inactivate a child workflow module upon completion of a workflow being performed by the child workflow module.

16. Non-transitory physical computer storage comprising instructions stored thereon that, when executed by one or more processors, are configured to at least:
access an order for at least one item; and
instantiate a master workflow engine configured to perform a master workflow to process the order, wherein performing the master workflow comprises:
identifying a plurality of child workflow templates based at least partially on the order, wherein each child workflow template is associated with a child workflow for performing a portion of a transaction process for completing the order; and
instantiating a plurality of child workflow modules, that when executed by a computing device, are configured to perform at least one child workflow corresponding to a child workflow template from the plurality of child workflow templates.

17. The non-transitory physical computer storage of claim 16, wherein the master workflow engine is selected from a plurality of master workflow engines based at least in part on the order.

18. The non-transitory physical computer storage of claim 16, wherein performing the master workflow further comprises:
generating a workflow descriptor configured to maintain status information for each of the plurality of child workflow modules; and
creating a workflow descriptor entry in the workflow descriptor for each child workflow initiated during processing of the order.

19. The non-transitory physical computer storage of claim 16, wherein performing the master workflow comprises:
determining whether a child workflow module from the plurality of child workflow modules has completed performing a first child workflow; and
in response to determining that the child workflow module has completed performing the first child workflow, causing the child workflow module to perform a second child workflow.

20. The non-transitory physical computer storage of claim 19, wherein the first child workflow and the second child workflow correspond to different child workflow templates.

21. The non-transitory physical computer storage of claim 16, wherein at least one child workflow module from the plurality of child workflow modules is configured to perform child workflows corresponding to a different child workflow template than at least one other child workflow module from the plurality of child workflow modules.

22. The non-transitory physical computer storage of claim 16, wherein performing the master workflow further comprises causing a child workflow module from the plurality of child workflow modules to perform a workflow a second time in response to the child workflow module failing to complete the workflow successfully a first time.

23. The non-transitory physical computer storage of claim 16, wherein performing the master workflow further comprises determining an interaction with a child workflow module from the plurality of child workflow modules based at least in part on a finite state machine.
